(19) United States
(12) Patent Application Publication
(10) Pub. No.: US 2004/0118873 A1
(43) Pub. Date: Jun. 24, 2004

(54) Telescoping closure

(76) Inventors: Donald D. Foster, St. Charles, MO (US); Philip L. Nelson, Wildwood, MO (US)

Correspondence Address: THOMPSON COBURN, LLP, ONE US BANK PLAZA, SUITE 3500, ST LOUIS, MO, 63101, US

(21) Appl. No.: 10/329,273

(22) Filed: Dec. 23, 2002

(51) Int. Cl. B67B 5/00

(52) U.S. Cl. 222/153.14; 222/521

(57) ABSTRACT

A telescoping closure is removably attached to a flexible container that can be manually squeezed to dispense contents of the container through the closure when the closure is moved to an opened position. The closure comprises a cap and a dispensing tip that are both mounted for rotation on a container connector that attaches the closure to the container. On rotation of the cap relative to the container connector the dispensing tip rotates with the cap and moves axially relative to the cap to project the dispensing tip axially outwardly from the cap and open an orifice in a distal end of the dispensing tip. With the orifice opened the contents of the container can be dispensed by inverting the container and cap and manually squeezing the container. The cap is rotated in an opposite direction to cause the dispensing tip to move axially back into the cap closing the orifice at the distal end.

### BACKGROUND OF THE INVENTION

(1) Field of the Invention

The present invention pertains to a closure for a container that is manually squeezed to dispense the contents of the container through the closure. Specifically, the present invention pertains to a telescoping closure that is removably attached to the container. The closure comprises a rotatable cap and a dispensing tip having a dispensing orifice at a distal end of the tip. On rotation of the cap the dispensing tip is moved from a closed position where the orifice is flush with the cap to an extended position of the tip relative to the cap where the orifice is opened. With the orifice opened the contents of the container can be dispensed through the telescoping closure by manually squeezing the container. The cap is also rotated to move the dispensing tip back to its retract position into the cap where the dispensing orifice of the tip is closed.

(2) Description of the Related Art

Manually squeezed dispensers are employed in dispensing a wide variety of products. A dispenser of this type typically includes a resilient, flexible bottle or container and a dispensing spout attached to the container. Dispensers of this type are commonly used in dispensing food condiments such as ketchup, mustard, and pancake syrup, but are also used in dispensing other products such as liquid soaps and glues. The flexibility and resiliency of the container enables it to be easily manually squeezed to exert a pressure on the contents of the container that forces a portion of the contents through the spout attached to the container. The spout often has an extended tip that facilitates directing the dispensed contents of the container to a desired area.

In order to keep the contents of the squeezable dispensers fresh in the case of food condiments, or to keep the contents from drying out in the case of glue or paint contents, the dispenser spout is often provided with a closure. A simple example of a prior art closure is a cap that is attached to the end of the spout by a short tether. The cap is fitted over the spout tip to close the outlet opening of the spout. Another example of a prior art closure employs a cap that is mounted to the end of the spout for reciprocating movement. The cap is manually pulled upwardly or away from the spout to move it to an opened position that allows dispensing of the container contents, or is pushed manually downwardly or toward the spout to move the cap to a closed position that prevents the dispensing of the container contents.

The prior art cap connected to the spout by the tether has been found to be disadvantaged in that, because the cap, tether and spout are often molded as one piece of plastic, the cap often gets in the way when dispensing contents from the container through the outlet opening of the spout. This results in some of the dispensed contents getting on the cap. In addition, because it is necessary to manually position the cap on the end of the spout and then pressing the cap downwardly on the spout to close the spout, the user's hand often comes in contact with the dispensed contents of the container and thus, use of the closure is undesirably messy.

The prior art cap that is pulled from the spout to open the spout and pushed toward the spout to close the spout also requires the user's hand to contact the cap to move it between its open and closed position. This also often results in the user's hand coming into contact with the dispensed contents of the container and the undesirable messy use of the closure.

When the contents of the container are food products such as mustard or pancake syrup, or the contents are products such as glue or paint, it can be appreciated that the messy operation of the prior art closure caps is very undesirable.

### SUMMARY OF THE INVENTION

The telescoping closure of the present invention overcomes the disadvantages associated with prior art manually squeezable container closures by providing a closure that is easily manually opened and closed without the users hand coming into contact with the dispensing tip of the closure. In addition, when the closure is opened the dispensing tip of the closure is extended outwardly, facilitating directing the dispensed contents of the container attached to the closure to the area desired.

The telescoping closure of the invention is comprised of three component parts in its basic construction. Each of the component parts is constructed of a plastic. In a variant embodiment of the basic construction of the closure, the closure is provided with a tubular valve that is also constructed of a plastic material, but a slightly more resilient plastic material than the other component parts of the closure. The basic component parts of the telescoping closure include a container connector, a cylindrical dispenser including a dispensing tip and a cylindrical enclosing cap.

In the preferred embodiment of the closure, the container connector is constructed similar to a typical cap that is screw threaded on to the screw threaded neck of a bottle. The container connector includes a cylindrical outer wall that has internal screw threading that mates with a screw threaded neck of a separate container to which the telescoping closure is to be attached. A locking tab projects outwardly from a bottom edge of the outer wall. A pair of cam surfaces are recessed into opposite sides of the outer wall exterior surface and spiral partially around the outer wall. An annular wall extends radially inwardly from the top edge of the outer wall to a cylindrical inner wall that is spaced radially inwardly from and is coaxial with the cylindrical outer wall. The inner wall surrounds a hollow interior bore of the container connector. A center post of the container connector is positioned at the center of the bore and an annular spacing between the inner wall and the center post defines a portion of a fluid flow path through the telescoping closure. The center post extends axially through the container connector and projects out of the center bore beyond the annular wall to a sealing surface at the distal end of the post.

The cylindrical dispenser is mounted in the center bore of the container connector. The dispenser has an axial length with opposite proximal and distal ends and a hollow interior bore that extends through the dispenser length. The dispenser interior bore defines the fluid flow path through the telescoping closure with the container connector interior bore. The proximal end of the dispenser is mounted in a sliding, sealing contact with the container connector interior bore that enables the dispenser to reciprocate axially relative to the container connector. The sliding, sealing connection also enables the dispenser to rotate relative to the container connector. The dispenser has a dispensing tip that projects axially outwardly from the container connector center bore to a distal end of the dispensing tip positioned outside the bore. An orifice passes through the dispensing tip distal end and communicates with the interior bore of the dispenser. The center post of the container connector is positioned in the interior bore of the dispenser in axial alignment with the dispensing tip orifice. The dispenser has a pair of cam followers positioned on radially opposite sides of the dispenser that engage in the cam grooves of the container connector. Thus, on relative rotation between the dispenser and the container connector in opposite directions, the dispenser cam followers slide through the container connector grooves and the spiral pattern of the grooves causes the dispenser to reciprocate axially relative to the container connector between a closed position and an opened position of the dispenser relative to the container connector. In the closed position the dispenser is retracted into the container connector interior bore and the sealing end of the container connector post is positioned in the dispensing tip orifice closing the orifice. In the opened position the dispenser and its dispensing tip are extended axially outwardly from the container connector center bore separating the dispenser tip orifice from the sealing distal end of the container connector post opening the orifice and opening the flow path through the closure.

The cap has a cylindrical outer wall that extends around both the container connector and the dispenser. The cap outer wall is mounted to the outer wall of the container connector to permit relative rotation between the cap and the container connector. A flexible flange is provided on the bottom edge of the cap outer wall that engages with the locking tab on the container connector to prevent relative rotation between the cap and the container connector. Manually flexing the resilient locking flange on the cap displaces it from the locking tab on the container connector enabling relative rotation between the cap and container connector. The cap has a circular end wall at its top edge that extends across the cap outer wall and encloses the container connector and the dispenser in an interior volume of the cap. The cap end wall has a center hole that is coaxially aligned with the container connecter center post and the dispensing tip orifice of the dispenser. The cap is operatively connected with the dispenser to cause the dispenser to rotate with the cap relative to the container connector on rotation of the cap, and to permit the dispenser to move axially relative to the cap and the container connector.

An optional tubular seal is mounted in the container connector center bore. The tubular seal has an interior bore that extends through the center of the seal to a conical flange at one end of the seal. The seal interior bore defines a portion of the fluid flow path through the closure. The conical flange at the end of the seal tapers inwardly and engages around the container connector center post sealing closed the fluid flow path through the closure. The conical flange is resiliently flexible and flexes away from the center post to open the fluid flow path through the closure when subjected to fluid under pressure from the container attached to the closure. The tubular seal can be eliminated from the telescoping closure as a cost saving measure.

In operation of the telescoping closure from its closed position, the dispensing tip of the dispenser is positioned inside the cap with the tip distal end positioned flush with the cap end wall. This positions the sealing surface at the end of the container connector post in the dispensing tip orifice closing the orifice. To open the orifice, the cap is rotated relative to the container connector. This causes the dispenser to rotate with the cap relative to the container connector. The cam followers of the dispenser slide through the cam grooves of the container connector causing the dispenser to move axially relative to the cap and container connector. This causes the dispensing tip of the dispenser to project axially outwardly through the cap end wall hole and separates the sealing surface at the distal end of the container connector center post from the orifice of the dispensing tip, thus opening the telescoping closure. Inverting the container and the attached closure will cause the contents of the container to pass through the opened closure by gravitation. Alternatively, squeezing the flexible container will also force the contents of the container through the opened closure. In the variant embodiment of the telescoping closure employing the tubular seal, it is necessary to squeeze the container to pressurize its contents which forces the contents through the interior bore of the seal and displaces the conical flange to open the fluid flow path through the telescoping closure. To close the telescoping closure it is merely necessary to rotate the cap in the opposite direction causing the dispenser to move axially toward the container connector and causing the dispensing tip orifice to move until the sealing surface at the distal end of the container connector post is received in the orifice, thus closing the closure.

From the description provided above it can be seen that the telescoping closure of the invention can be opened and closed by manually rotating the cap. Thus, it is not necessary to handle a dispensing tip to open and close the closure. Furthermore, the dispensing tip projecting outwardly from the cap when the closure is opened facilitates the use of the tip in directing the dispensed contents from the container. From the telescoping closure and its use described above, it can be seen that the telescoping closure of the present invention overcomes the disadvantages associated with prior art closures of this type.

### BRIEF DESCRIPTIONS OF THE DRAWINGS

Further features of the invention are revealed in the following detailed description of the preferred embodiment of the invention and in the drawing figures wherein:

FIG. 1 is a perspective view of the telescoping closure of the invention in its closed position;

FIG. 2 is a perspective view of the telescoping closure of the invention in its opened position;

FIG. 3 is a side elevation view of the closure in its closed position;

FIG. 4 is a side elevation view of the closure in its opened position;

FIG. 5 is a side elevation view of the closure in its closed position and rotated ninety degrees from its position shown in FIG. 3;

FIG. 6 is a side elevation view of the closure in its opened position and rotated ninety degrees from its position shown in FIG. 3;

FIG. 7 is a cross section elevation view of the closure along the line 7-7 of FIG. 3;

FIG. 8 is a cross section side elevation view of the closure along the line 8-8 of FIG. 4;

FIG. 9 is a cross section elevation view of the closure along the line 9-9 of FIG. 5; and

FIG. 10 is a cross section elevation view of the closure along the line 10-10 of FIG. 6.

### DETAILED DESCRIPTION OF THE PREFERRED EMBODIMENTS

As stated earlier, the telescoping closure 10 of the present invention is comprised of three component parts in its basic construction. These basic component parts of the closure include a container connector 12, a cylindrical dispenser 14 including a dispensing tip 16, and a cylindrical enclosing cap 18. Each of these component parts is preferably constructed of a plastic material. In a variant embodiment of the telescoping closure its basic construction includes a tubular valve 22 that is also constructed of a plastic material, but the material is slightly more flexible and resilient than the material of the other component parts of the closure. As a cost saving measure, the tubular seal 22 can be eliminated from the construction of the telescoping closure.

The container connector 12 has a cylindrical outer wall 24 with a center axis 26 and axially opposite lower 28 and upper 32 ends. An annular rim 34 projects radially outwardly from the exterior surface of the outer wall 24 adjacent its lower end 28. A pair of cam grooves 36 each formed by opposing pairs of cam surfaces are recessed into the exterior surface of the outer wall 24. The cam grooves 36 spiral around portions of the outer wall exterior surface. A screw thread 38 spirals around the opposite interior surface of the outer wall 24. The screw thread is designed to mate with a complimentary thread on the neck of a container to which the closure is to be attached. A locking tab 40 projects radially outwardly from the lower end 28 of the container connector outer wall 24. An annular wall 42 extends radially inwardly from the upper end 32 of the container connector outer wall 24. The annular wall 42 extends inwardly to a cylindrical inner wall 44 of the container connector. The cylindrical inner wall 44 extends axially downwardly from the annular wall 42 from an upper end 46 of the inner wall to a lower end 48 of the inner wall. The inner wall 44 has a cylindrical interior surface 52 that surrounds a hollow center bore 54 of the container connector 12 and defines a portion of the fluid flow path through the telescoping closure 10. A pair of arms 62 extend radially inwardly from the lower end 48 of the inner wall 44 to a center post 64 of the container connector. The pair of arms 62 are positioned on opposite sides of the center post 64 and do not obstruct the fluid flow path through the center bore 54 of the container connector. The center post 64 is cylindrical and is coaxial with the container connector. The post 64 extends through the container connector center bore 54 from a proximal or lower end 66 of the post to an upper or distal end 68 of the post. The post upper end 68 has a circular surface that functions as a sealing surface of the tubular closure as will be explained. As seen in the drawing figures, the post 64 has an axial length that positions the upper sealing end surface 68 of the post outwardly from the container connector center bore 54 and outwardly from the container connector annular wall 42.

The dispenser 14 is comprised of a cylindrical wall 72 that extends axially between a lower end 74 of the wall and an upper end 76 of the wall. A portion of the dispenser wall adjacent its lower end 74 angles radially outwardly and engages with the interior surface 52 of the container connector inner wall 44. The engagement between the dispenser wall lower end 74 and the container connector inner wall 44 provides a sliding sealing engagement between the dispenser 14 and the container connector that enables the dispenser to move both in rotation and axially relative to the container connector. The dispenser wall 72 surrounds a hollow interior bore 78 of the dispenser that forms a portion of the fluid flow path through the telescoping closure. The upper end 76 of the dispenser wall is connected to a planar flange 82 that extends across the upper end 76 of the dispenser with portions of the flange 82 projecting radially outwardly from opposite sides of the dispenser. The opposite portions of the flange 82 project radially outwardly to a pair of arms 84 that depend downwardly over the exterior surface of the container connector outer wall 24. The arms 84 each have a cam follower 86 that projects radially inwardly from the arm into one of the cam grooves 36 of the container connector outer wall. The cam followers 86 engage in a sliding engagement against the opposite cam surfaces that form each of the cam grooves 36. A cylindrical sealing wall 88 projects axially upwardly from the dispenser flange 82 in axial alignment with the dispenser wall 72. Like the lower end 74 of the dispenser wall 72, the cylindrical sealing wall 88 also angles radially outwardly as it extends axially away from the dispenser flange 82. Positioned within the sealing wall 88 is the cylindrical dispensing tip 16 of the dispenser. The dispensing tip 16 extends axially outwardly from the flange 82 and beyond the sealing wall 88 of the dispenser to a distal end wall 104 of the tip. The dispensing tip 16 has a hollow interior bore 106 that communicates with the interior bore 78 of the dispenser wall 72. Together the dispensing tip interior bore 106 and the dispenser wall interior bore 78 form a portion of the fluid flow path through the telescoping closure. The dispensing tip end wall 104 has an orifice 108 passing there through that communicates with the dispensing tip interior bore 106. The orifice 108 is coaxial with the container connector center bore 58 and with the container connector center post 64.

The cap 18 has a cylindrical side wall 112 with axially opposite lower 114 and upper 116 ends. The cap side wall 112 has a diameter dimension and an axial length dimension that enables the container connector 12 and the dispenser 14 to be contained inside an interior volume of the cap surrounded by the side wall 112. A resilient flexible locking flange 118 projects radially outwardly from the cap side wall 112 at its lower end 114. A pair of slots 122 is formed into the cap side wall 112 on opposite sides of the locking flange 118 giving the flange its flexibility and resiliency. A cavity 124 is formed into the interior surface of the flange 118. The cavity 124 is dimensioned to receive the locking tab 40 of the container connector as will be explained. An annular lip 126 is formed on the interior surface of the cap side wall 112 adjacent the side wall lower end 114. The annular lip 126 extends completely around the cap interior surface. The annular lip 126 engages in sliding contact with the underside of the annular rim 34 on the container connector outer wall 24 to mount the cap 18 to the container connector 12 for rotational movement of the cap relative to the container connector. The cap has an end wall 132 at the cap upper end 116 that extends across the cap side wall 112 and together with the side wall encloses the interior volume 128 of the cap. The cap end wall 132 has a hole 134 at its center that is dimensioned to receive the dispensing tip 16 of the dispenser 14 through the hole. A pair of parallel, radially spaced interior walls 136 extend downwardly from the interior surface of the cap end wall 132 to a distal ends 138 of the interior walls positioned adjacent the annular wall 42 of the container connector. The pair of interior walls 136 extend radially across the cap end wall interior surface and the radial spacing between the interior walls defines a notch 142 that receives the dispenser flange portions 82. The positioning of the dispenser flanges 82 in the cap notch 142 between the interior walls 136 operatively connects the cap 18 to the dispenser 14 to cause the dispenser to rotate with the cap when the cap is rotated relative to the container connector 12, but allows the dispenser 14 to move axially relative to the cap 18 with the dispenser flange portions 82 moving through the notch 142 between the interior walls 136 when the cap is rotated relative to the container connector. Inside the cap interior walls 136 the cap has a cylindrical sealing wall 146 that receives the cylindrical sealing wall 88 of the dispenser 14 in a sliding sealing engagement in its interior.

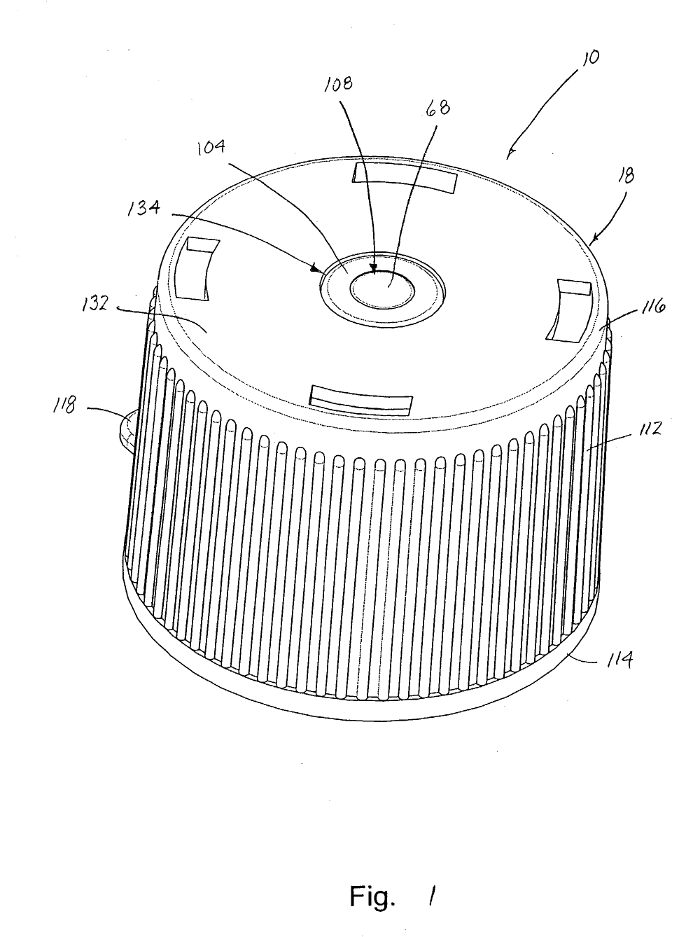

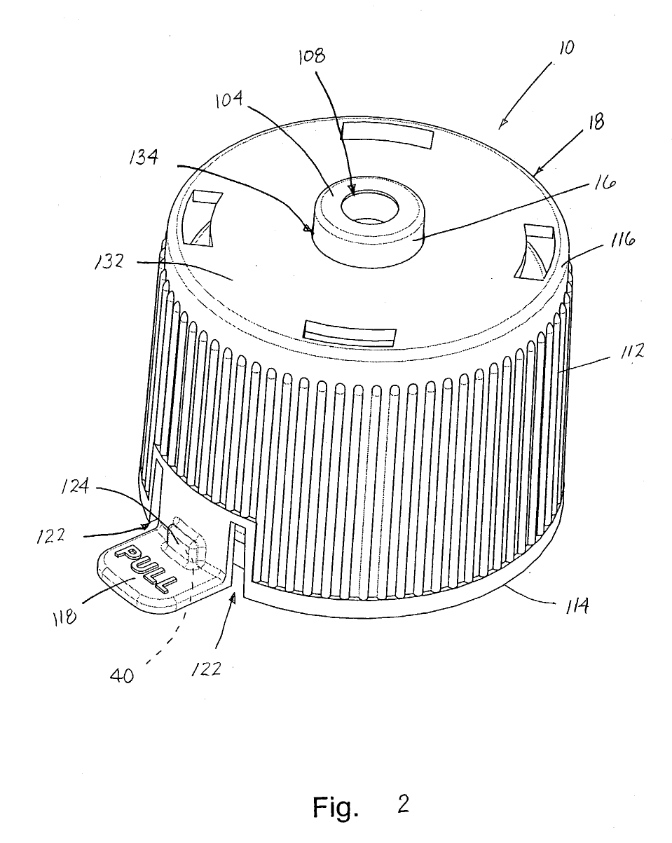

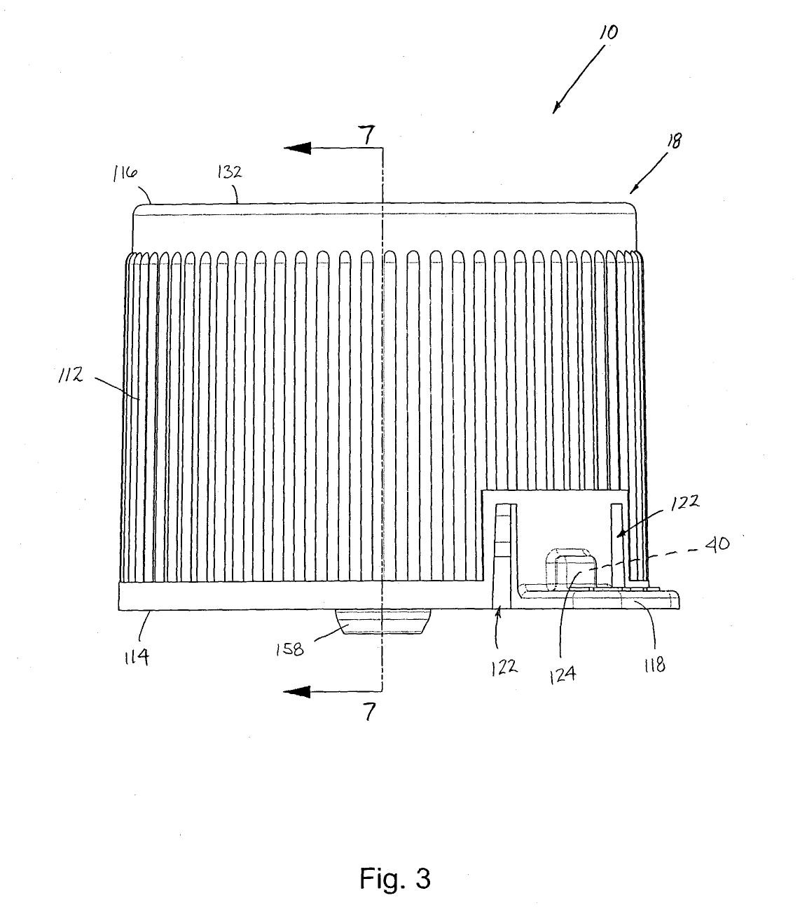

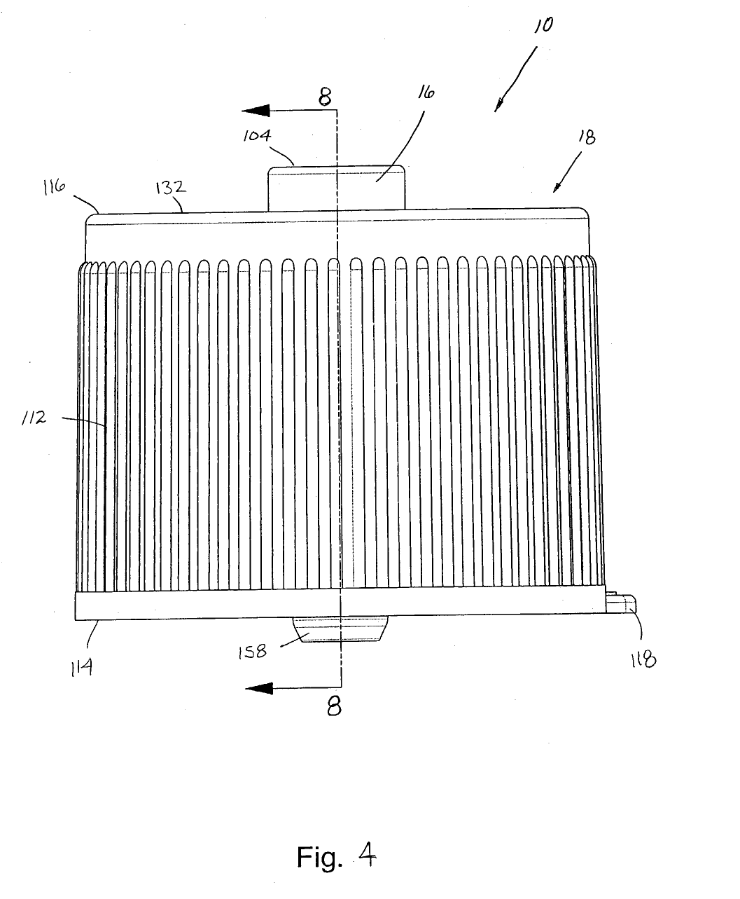

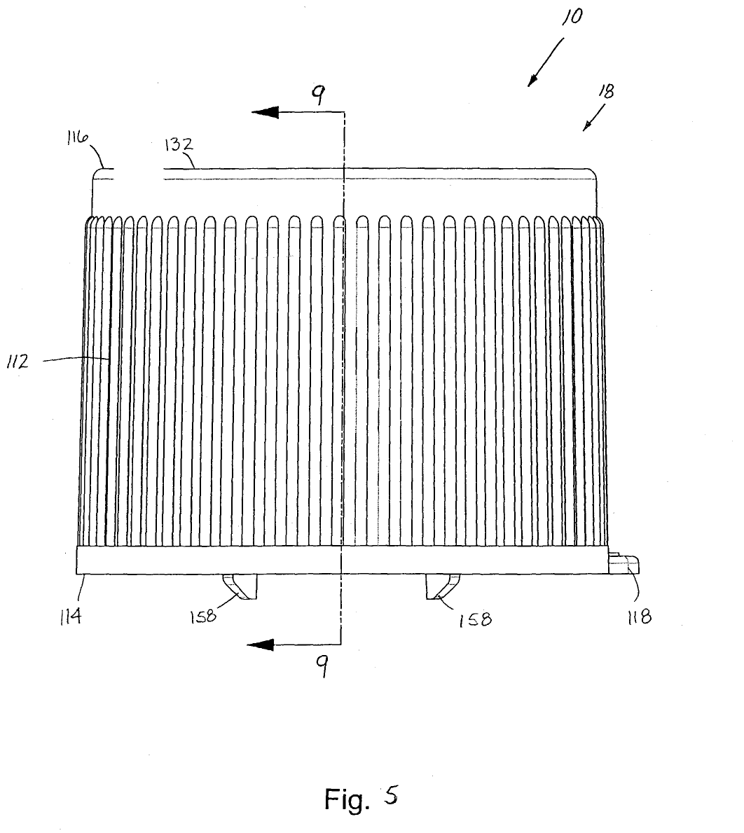

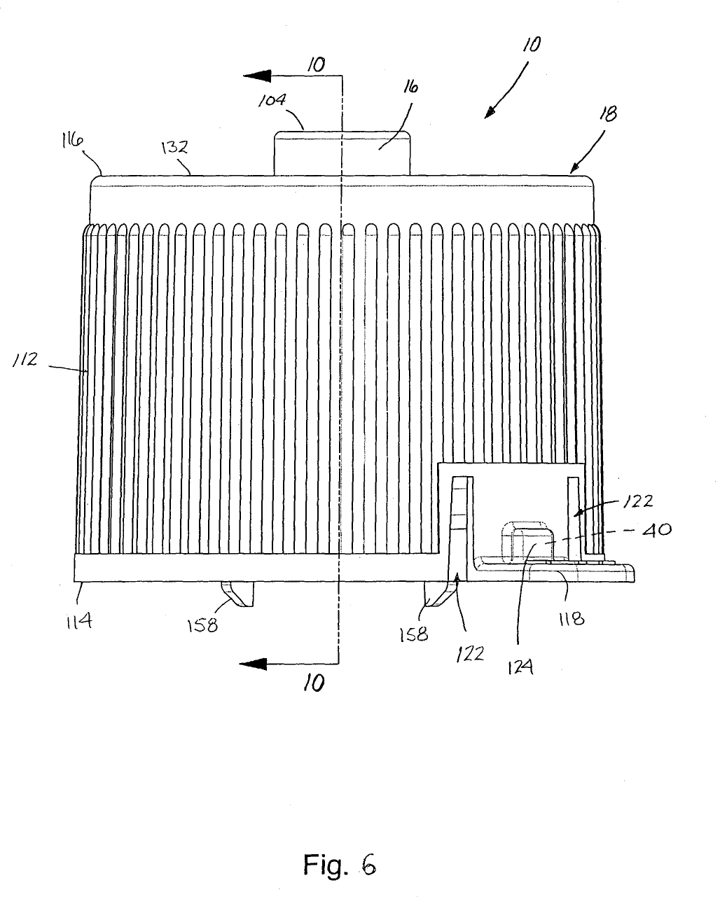

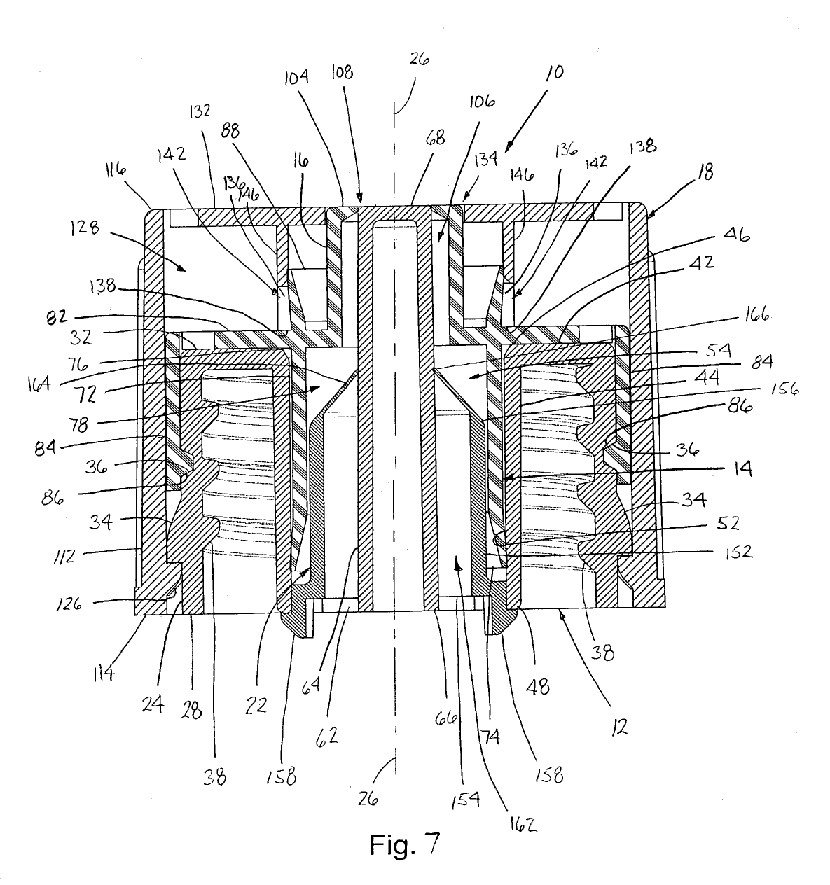

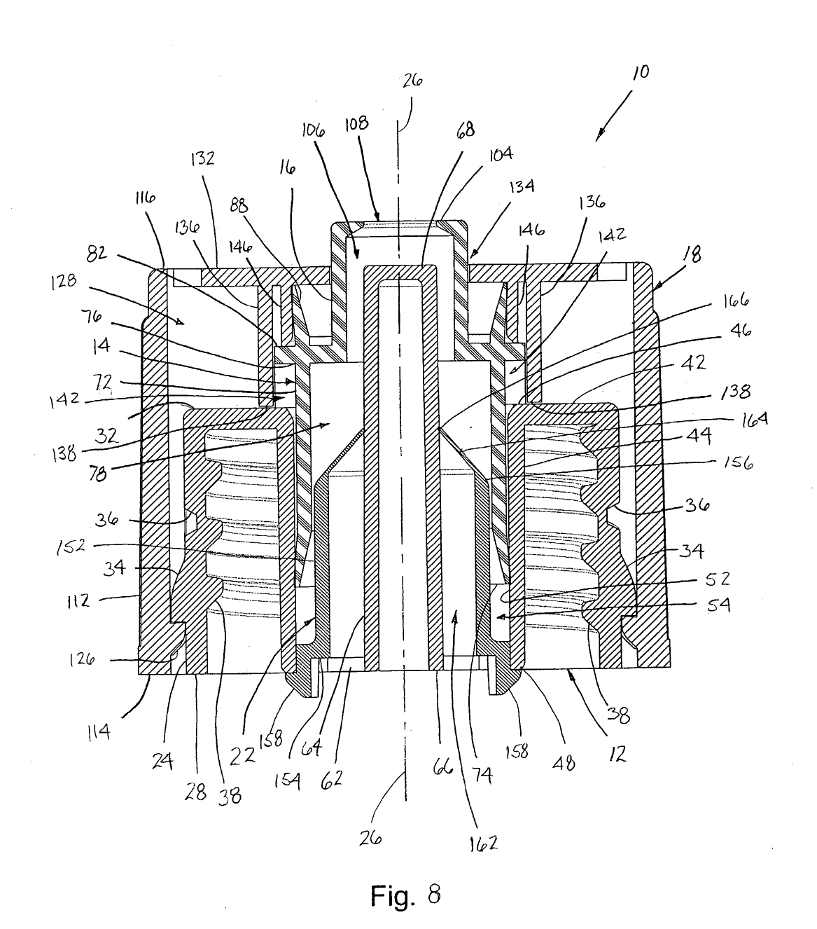

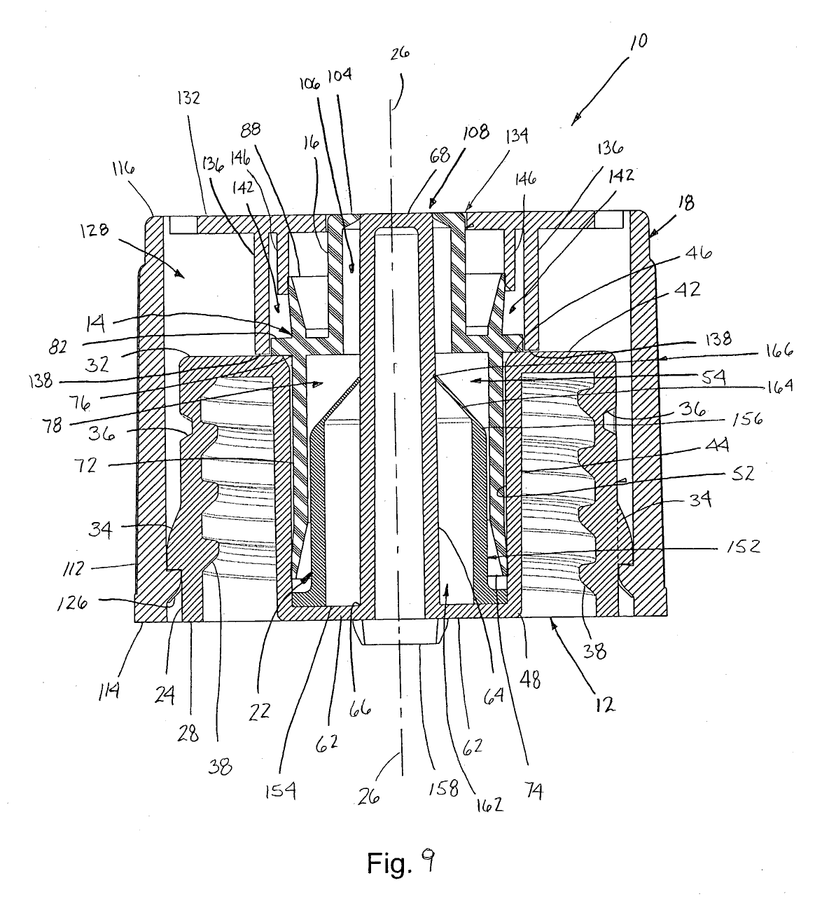

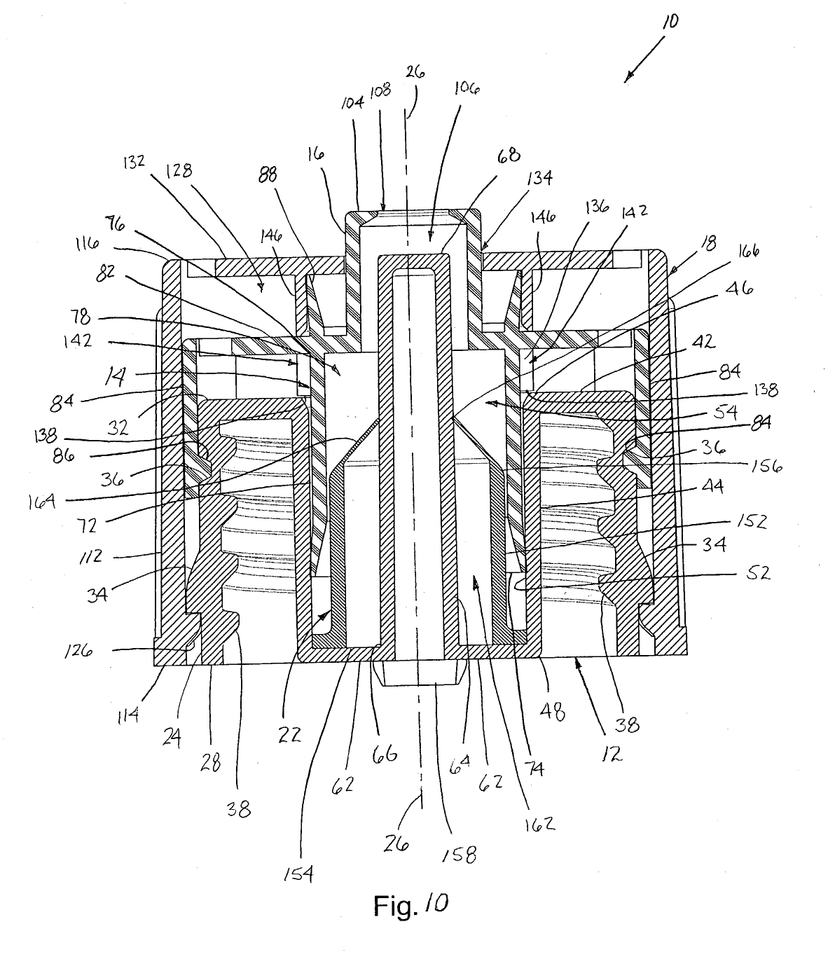

In the operation of the telescoping closure 10 from its closed position shown in FIGS. 1, 3, 5, 7 and 9, the dispensing tip 16 of the dispenser 14 is positioned inside the cap 18 with the distal end surface 104 of the tip positioned in the cap hole 134 in the same plane as the cap end wall 132. In this position of the dispensing tip 16 the upper end 68 of the container connector center post 64 is inserted into the orifice 108 of the dispensing tip and seals closed the orifice. To open the orifice 108, the locking flange 118 is flexed away from the locking tab 40 and the cap 18 is rotated relative to the container connector 12. This causes the dispenser 14 to also rotate with the cap 18 relative to the container connector 12. As the dispenser 14 rotates relative to the container connector 12, the dispenser cam followers 86 slide through the cam grooves 36 on the container connector outer wall 24 causing the dispenser 14 to move axially relative to the container connector 12 and relative to the cap 18. The dispenser 14 moves upwardly from its position shown in FIGS. 7 and 9 with the dispenser flange portions 82 moving upwardly through the notch 142 between the pair of interior walls 136. The lower end 74 of the dispenser cylindrical wall 72 rotates and slides axially upwardly across the container connector inner wall interior surface 52. The dispenser sealing wall 88 slides axially upwardly across the interior of the cap cylindrical sealing wall 146. The dispensing tip 16 of the dispenser emerges from the cap end wall hole 134 and the dispensing tip orifice 108 separates from the upper end 68 of the container connector center post 64 opening the orifice. Rotation of the cap 18 relative to the container connector 12 is continued until the cam followers 86 travel through the grooves to the ends of the grooves 36. This positions the dispensing tip 16 at its dispensing position projecting axially outwardly from the cap end wall 132 as shown in FIGS. 2, 4, 6, 8 and 10. Inverting the closure 10 and a container (not shown) to which the closure is attached will cause the contents of the container to pass through the opened closure by gravitation. Alternatively, squeezing the flexible container will pressurize the contents of the container and force them through the opened closure. To close the telescoping closure 10 the cap 18 is rotated in the opposite direction relative to the container connector 12. This will cause the dispensing tip 16 to return to its closed position shown in FIGS. 1, 3, 5, 7 and 9.

In the variant embodiment of the telescoping closure 10 the tubular seal 22 is assembled inside the center bore 54 of the container connector 24 and the interior bore 78 of the dispenser 14. The tubular seal 22 has a cylindrical wall 52 that extends axially through the telescoping closure 10 between a bottom end 154 and a top end 156 of the wall. A pair of resilient fingers 158 project from the seal bottom end 154 between the arms 162 that connect the container connector center post 64 to the container connector inner wall 44. The fingers 158 engage beneath the container connector inner wall 44 and secure the tubular seal 22 in the container connector center bore 54. The tubular seal cylindrical wall 152 has an interior bore 162 that extends between the bottom end 154 and top end 156 of the wall and forms a portion of the fluid flow path through the telescoping closure 10. A resiliently flexible conical flange 164 projects axially from the tubular seal wall top end 156 and tapers inwardly toward the container connector center post 64. A distal edge 166 of the conical flange 164 engages in sealing contact around the center post 64. The engagement of the conical flange distal end 166 around the center post 64 seals closed the fluid flow path through the telescoping closure 10. With the telescoping closure attached to a separate container (not shown), if the closure and container were turned on their side or inverted with the closure in its opened position, the conical flange 164 engaging with the container connector center post 64 would prevent the contents of the container from leaking through the telescoping closure 10. In order to dispense the contents of the container through the telescoping closure 10 employing the tubular seal 22, with the closure moved to its opened position it is necessary to squeeze the container to exert pressure on the contents and force the contents through the interior bore 162 of the tubular seal. The pressure the contents exerts on the conical flange 164 of the seal causes the flange to resiliently flex away from the container connector center post 64 opening the fluid flow path through the closure. When the squeezing of the container is stopped the pressure on the contents of the container is relieved and the resilient flexibility of the seal conical flange 64 causes it to return to its sealed position with the flange distal end 66 engaging around the container connector center post 64.

From the description of the invention and its method of use provided above, it can be seen that the telescoping closure of the invention can be opened and closed by manually rotating the cap. Thus, it is not necessary to handle a dispensing tip to open and close the closure. Furthermore, the dispensing tip projecting axially outwardly from the cap when the closure is opened facilitates the use of the tip in directing the dispensed contents from the container. From the telescoping closure and its use described above, it can be seen that the telescoping closure of the present invention overcomes the disadvantages associated with prior art closures.

While the present invention has been described above by reference to specific embodiments, it should be understood that modifications and variations of the invention may be constructed without departing from the scope of the invention defined in the following claims.

What is claimed is:

1) A container closure comprising:
a container connector that is connectable to a separate container to attach the closure to the container, the container connector having a center axis;
a dispensing tip mounted coaxially on the container connector for axial movement of the dispensing tip between closed and opened positions of the dispensing tip relative to the container connector where in the dispensing tip closed position the container closure prevents contents of the container from being dispensed from the container through the container closure and in the dispensing tip opened position the container closure permits contents of the container to be dispensed from the container through the container closure; and
a cap having an interior volume containing the container connector and the dispensing tip, the cap being mounted coaxially on the container connector for rotational movement of the cap around the container connector center axis, the cap being operatively connected to the dispensing tip to cause the dispensing tip to move between the closed and opened positions of the dispensing tip relative to the container connector in response to rotational movement of the cap on the container connector.

2) The container closure of claim 1, further comprising:
the container connector being connectable to the separate container whereby the container connector is stationary relative to the container as the cap is rotated on the container connector.

3) The container closure of claim 1, further comprising:
the container connector being entirely contained inside the cap interior volume.

4) The container closure of claim 1, further comprising:
the cap having a cylindrical side wall and an end wall that extends across the side wall, the end wall having a hole; and,
the dispensing tip being positioned in the end wall hole in the dispensing tip closed position and the dispensing tip projecting through the end wall hole beyond the end wall in the dispensing tip opened position.

5) The container closure of claim 4, further comprising:
the end wall hole being positioned in a plane; and
the dispensing tip having an axial length and an orifice at one end of the dispensing tip length where the orifice is positioned in the plane of the end wall hole when the dispensing tip is in the dispensing tip closed position and the orifice being displaced from the end wall hole when the dispensing tip is in the dispensing tip opened position.

6) The container closure of claim 4, further comprising:
the cap being operatively connected to the dispensing tip to cause the dispensing tip to rotate with the cap and to move axially between the dispensing tip closed and opened positions relative to the cap.

7) The container closure of claim 6, further comprising:
the container connector having a cam surface; and
the dispensing tip having a cam follower in sliding engagement with the container connector cam surface whereby the cam slides along the cam surface as the dispensing tip rotates with the cap and the cam surface moves the dispensing tip axially between the closed and opened positions of the dispensing tip.

8) The container closure of claim 5, further comprising:
the container connector having a coaxial center post with a distal end positioned relative to the dispensing tip where the distal end engages in and closes the orifice in the closed position of the dispensing tip and the distal end is displaced from the orifice in the opened position of the dispensing tip.

9) The container closure of claim 1, further comprising:
the dispensing tip having an orifice that is coaxial with the container center axis; and,
the container connector having a sealing surface positioned relative to the dispensing tip where the sealing surface engages with the dispensing tip and closes the orifice in the closed position of the dispensing tip and the sealing surface is displaced from the orifice in the opened position of the dispensing tip.

10) The container closure of claim 9, further comprising:
the container connector having a coaxial center post having a length with a distal end and the sealing surface being on the center post distal end.

11) The container closure of claim 10, further comprising:
the dispensing tip having a tubular, axial length with the orifice at one end of the length and a hollow interior bore extending through the dispensing tip length to the orifice; and
the center post extends through the dispensing tip interior bore.

12) The container connector of claim 11, further comprising:
the cap having a cylindrical side wall and an end wall extending across the side wall, the end wall having a hole positioned in a plane; and
the dispensing tip orifice being positioned in a plane that is coplanar with the end wall hole plane when the dispensing tip is in the closed position.

13) The container closure of claim 10, further comprising:
the dispensing tip having a hollow interior bore that communicates with the orifice; and
a flexible, resilient tubular seal in the dispensing tip interior bore that resiliently engages around the container connector center post to close the dispensing tip interior bore and resiliently flexes away from the container connector center post to open the dispensing tip center bore in response to an increase in pressure of contents of the separate container.

14) The container closure of claim 1, further comprising:
the container connector having a locking tab that projects outwardly from the container connector; and,
the cap having a locking flange positioned on the cap to engage over the locking tab when the dispensing tip is in the closed position to prevent the cap from rotating relative to the container connector, the locking flange being resiliently flexible to disengage the locking flange from the container connector locking tab by flexing the locking flange away from the tab.

15) A container closure comprising:
a container connector that is connectable to a separate container to connect the closure to the container, the container connector having a hollow center bore with a center axis and a coaxial center post in the center bore, the center post having a distal end surface; and,
a dispensing tip having an orifice, the dispensing tip being mounted at least partially in the container connector center bore and being operatively connected to the container connector to cause the dispensing tip to move axially between a closed position and an opened position of the dispensing tip relative to the container connector in response to rotational movement of the dispensing tip relative to the container connector where in the dispensing tip closed position the container connector center post is position in the dispensing tip orifice closing the orifice and in the dispensing tip opened position the container connector center post is removed from the dispensing tip orifice opening the orifice.

16) The container closure of claim 15, further comprising:
the container connector being connectable to a separate container to be stationary relative to the container as the dispensing tip, is moved axially in response to rotational movement of the dispensing tip relative to the container connector.

17) The container closure of claim 15, further comprising:
the dispensing tip having a cylindrical exterior surface mounted is sliding engagement with the container connector in the container connector center bore.

18) The container closure of claim 17, further comprising:
the container connector having a cylindrical interior surface surrounding the container connector center bore; and
the dispensing tip exterior surface engaging in sealing engagement with container connector interior surface.

19) The container closure of claim 15, further comprising:
the dispensing tip having a hollow interior bore extending through the dispensing tip and communicating with the orifice; and,
the container connector center post extending through the dispensing tip interior bore.

20) The container closure of claim 19, further comprising:
the dispensing tip having a length between axially opposite distal and proximal ends of the dispensing tip, the orifice being at the dispensing tip distal end and the dispensing tip proximal end engaging in sliding, sealing engagement with the container connector interior surface.

21) The container closure of claim 15, further comprising:
the container connector having a cam surface; and,
the dispensing tip having a cam follower that engages in sliding engagement with the cam surface where the cam surface is shaped to move the dispensing tip axially relative to the container connector in response to the dispensing tip being rotated relative to the container connector.

22) The container closure of claim 15, further comprising:
a cap mounted on the container connector for rotation of the cap around the container connector, the cap being operatively connected to the dispensing tip for rotation of the dispensing tip with the cap and for axial movement of the dispensing tip relative to the cap.

23) The container closure of claim 22, further comprising:
the cap having a cylindrical side wall that surrounds the container cap and dispensing tip and the cap having a circular end wall that extends across the side wall and over the container connector and dispensing tip, the end wall having a center hole.

24) The container closure of claim 23, further comprising: the dispensing tip being positioned within the cap center hole in the closed position of the dispensing tip and the dispensing tip being position projecting through the cap center hole and beyond the cap end wall in the opened position of the dispensing tip.
